(19) United States
(12) Patent Application Publication
(10) Pub. No.: US 2024/0070733 A1
(43) Pub. Date: Feb. 29, 2024

(54) PENDING EVENT IDENTIFICATION AND ESTIMATION

(71) Applicant: Truist Bank, Charlotte, NC (US)

(72) Inventors: James Harrison Creager, Raleigh, NC (US); Michaela Rose Cestari, Cary, NC (US)

(73) Assignee: Truist Bank, Charlotte, NC (US)

(21) Appl. No.: 17/897,712

(22) Filed: Aug. 29, 2022

(51) Int. Cl. G06Q 30/02

(52) U.S. Cl. CPC G06Q 30/0283; G06Q 30/0201

(57) ABSTRACT

A computing device can receive a notification associated with a transaction. The computing device can access a machine-learning model trained on historical data associated with the transaction to identify an estimated final value of the transaction. The computing device can apply the machine-learning model to a preliminary value associated with the transaction to determine an estimated final value for the transaction. The computing device can output the estimated final value for the transaction to a graphical user interface.

### TECHNICAL FIELD

The present disclosure relates generally to analyzing data. More specifically, but not exclusively, certain aspects of the present disclosure relate to identifying and estimating values associated with pending events.

### BACKGROUND

In some cases, users can initiate transactions with entities. Similarly, entities can initiate transactions with users. But some transactions may not be resolved immediately. For certain transactions, there may be a waiting period or delay before the transaction is resolved. While a transaction has not yet been resolved, the transaction can be displayed to the user as being ‘pending’ with a value that is different from a value of the transaction when posted.

### SUMMARY

In some examples, a computer-implemented method includes receiving, by a processor, a notification associated with a transaction. The method further includes accessing, by the processor, a machine-learning model trained on historical data associated with the transaction to identify an estimated final value of the transaction. Additionally, the method includes applying, by the processor, the machine-learning model to a preliminary value associated with the transaction to determine an estimated final value for the transaction. Further, the method includes outputting, by the processor, the estimated final value for the transaction to a graphical user interface.

In an additional example, a system includes a processor and a memory comprising program code that is executable by the processor for causing the processor to perform operations. The operations include receiving a notification associated with a transaction. The operations also include accessing a machine-learning model trained on historical data associated with the transaction to identify an estimated final value of the transaction. Additionally, the operations include applying the machine-learning model to a preliminary value associated with the transaction to determine an estimated final value for the transaction. Further, the operations include outputting the estimated final value for the transaction to a graphical user interface.

In an additional example, a non-transitory computer-readable medium includes program code that is executable by a processor for causing the processor to perform operations. The operations include receiving a notification associated with a transaction. The operations also include accessing a machine-learning model trained on historical data associated with the transaction to identify an estimated final value of the transaction. Additionally, the operations include applying the machine-learning model to a preliminary value associated with the transaction to determine an estimated final value for the transaction. Further, the operations include outputting the estimated final value for the transaction to a graphical user interface.

### BRIEF DESCRIPTION OF DRAWINGS

FIG. 1 is an illustration of a graphical user interface for identifying and estimating values associated with pending events, according to some examples of the present disclosure.

FIG. 2 is an illustration of an insight tab that can be used for identifying and estimating values associated with pending events, according to some examples of the present disclosure.

FIG. 3 is an illustration of an updated graphical user interface for identifying and estimating values associated with pending events, according to some examples of the present disclosure.

FIG. 4 is a block diagram of a system for identifying and estimating values associated with pending events, according to some examples of the present disclosure.

FIG. 5 is a flowchart of a process for identifying and estimating values associated with pending events according to some examples of the present disclosure.

### DETAILED DESCRIPTION

Certain aspects and features relate to identifying and estimating values associated with pending events. For example, a pending event can include a transaction. A user can initiate a transaction. A computing device can identify and estimate values associated with a pending event. For example, the computing device can receive a notification associated with the pending event. Some pending events may not resolve immediately. For example, there may be a waiting period associated with the pending event that must expire prior to resolution of the pending event. During this waiting period, the computing device can receive or assign a preliminary value associated with the pending event. Once the pending event has been resolved, it will be assigned a final value. As a result, the value associated with the pending event may not be accurate until the pending event has been resolved. For example, there can be a possibility that the preliminary value is not the same as the final value that will be assigned to the pending event in the future. It may be desirable to estimate a likelihood of the preliminary value will be different from the final value. Similarly, it may also be desirable to estimate the final value.

The computing device can receive a notification associated with a pending event. For example, the notification can indicate a pendency of the pending event. The notification can also include details or metadata associated with the pending event. For example, the notification can include the preliminary value, as well as information corresponding to an entity, such as a company or location, associated with the pending event.

The computing device can access an identifying machine-learning model trained to identify whether a pending event is likely to change when the pending event ultimately posts. The machine-learning model may be trained to identify whether pending events are likely to change upon posting using a corpus of historical data associated with historical transactions. In some examples, the machine-learning model can accept metadata or other data associated with the pending event as input. The computing device can apply the identifying machine-learning model to a pending event to identify a confidence score associated with a likelihood that a preliminary value of the pending event will change. In response to determining that the confidence value exceeds a confidence value threshold, the computing device can output an indication to a graphical user interface that the preliminary value will likely change. In some examples, computing device can apply the machine-learning model to pending events automatically to determine which pending events require an estimated final value.

The computing device can also access an estimating machine-learning model that is trained to estimate a final value associated with the pending event. The estimating machine-learning model may be trained to estimate such a change using historical data associated with historical transactions that have values that change between pendency and posting. For example, the historical data can be associated with historical pending events. The historical data can include a collection of historical pending events that may have been initiated by one or more users. The computing device can apply the estimating machine-learning model to preliminary values that have been indicated as likely to change to determine an estimated final value for the pending event. The computing device can display the estimated final value for the pending event to the user by outputting the estimated final value to the graphical user interface. In some examples, the graphical user interface can be displayed on a personal computer or mobile device.

In the following description, for the purposes of explanation, specific details are set forth in order to provide a thorough understanding of various implementations and examples. Various implementations may be practiced without these specific details. For example, circuits, systems, algorithms, structures, techniques, networks, processes, and other components may be shown as components in block diagram form in order not to obscure the implementations in unnecessary detail. The figures and description are not intended to be restrictive.

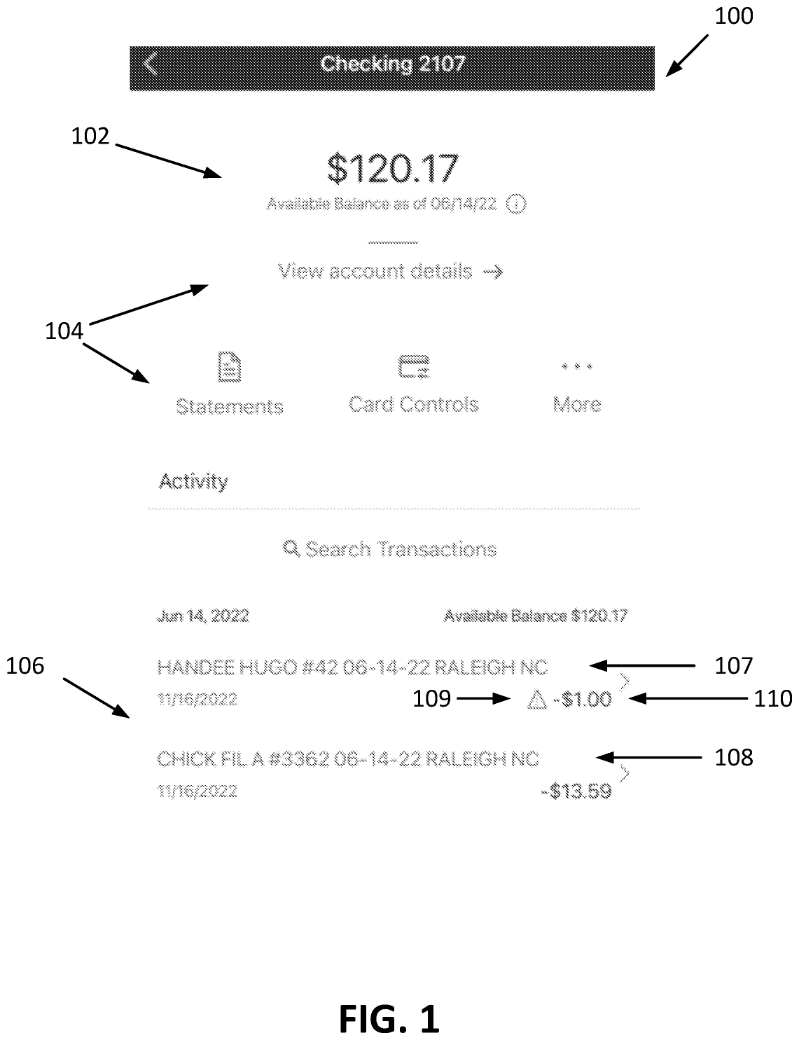

FIG. 1 is an illustration of a graphical user interface 100 for identifying and estimating values associated with pending events according to some examples of the present disclosure. The user can access the graphical user interface 100 via a mobile device or personal computer. The graphical user interface 100 can display a quantity 102 associated with a user account. For example, the quantity 102 can be a current balance associated with the user account. The graphical user interface can also display a date associated with the quantity 102, such as a data corresponding to the most recent update to the quantity 102. In some examples, the graphical user interface 100 can include a set of interactive graphical objects 104. The interactive graphical objects 104 can provide the user with access to account data and account functions associated with the user account.

The graphical user interface 100 can display a list of events 106. The list of events 106 can include pending events 107 and posted events 108. The graphical user interface 100 can display a value 110 corresponding to each pending event 107 and posted event 108 in the list of events 106. For example, the value 110 corresponding to the pending event 107 can be a preliminary value 110. The preliminary value 110 may be uncorrelated with an expected final value associated with the pending event 107. To indicate that the pending event 107 is pending, the graphical user interface 100 can display an interactive marker 109 corresponding to the pending event 107. In some examples, the user can interact with interactive marker 109 to cause the graphical user interface 100 to display an insight tab.

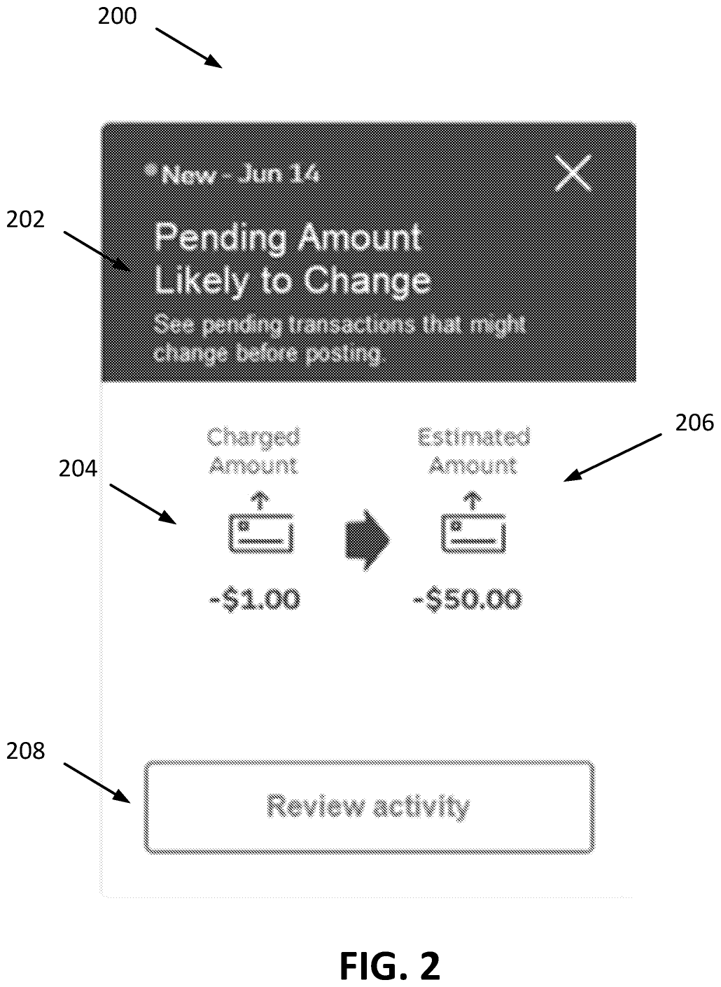

FIG. 2 is an illustration of an insight tab 200 for identifying and estimating values associated with pending events according to some examples of the present disclosure. In some examples, the insight tab 200 can be instantiated in response to the user interacting with the interactive marker 109 of FIG. 1. The insight tab 200 can include a message 202 associated with the pending event. The message 202 can include text that indicates to the user that a value associated with a pending event is likely to change. Indicating that the value is likely to change can enable the user to take action associated with the pending event 107. The insight tab 200 can include the preliminary value 204 associated with the pending event and an estimated final value 206 associated with the pending event. The computing device can determine the estimated final value 206 with a machine-learning model that has been trained on historical data. For example, the machine learning method can be trained on a historical dataset that can include a number of historical transactions. By providing the user with the estimated final value 206 and the preliminary value 204, the insight tab 200 can provide the user with actionable information regarding the pending event 107. The user can select a link 208 that can cause the computing device to display a second graphical user interface that can enable the user to review or adjust a value or other information related to the pending event 107.

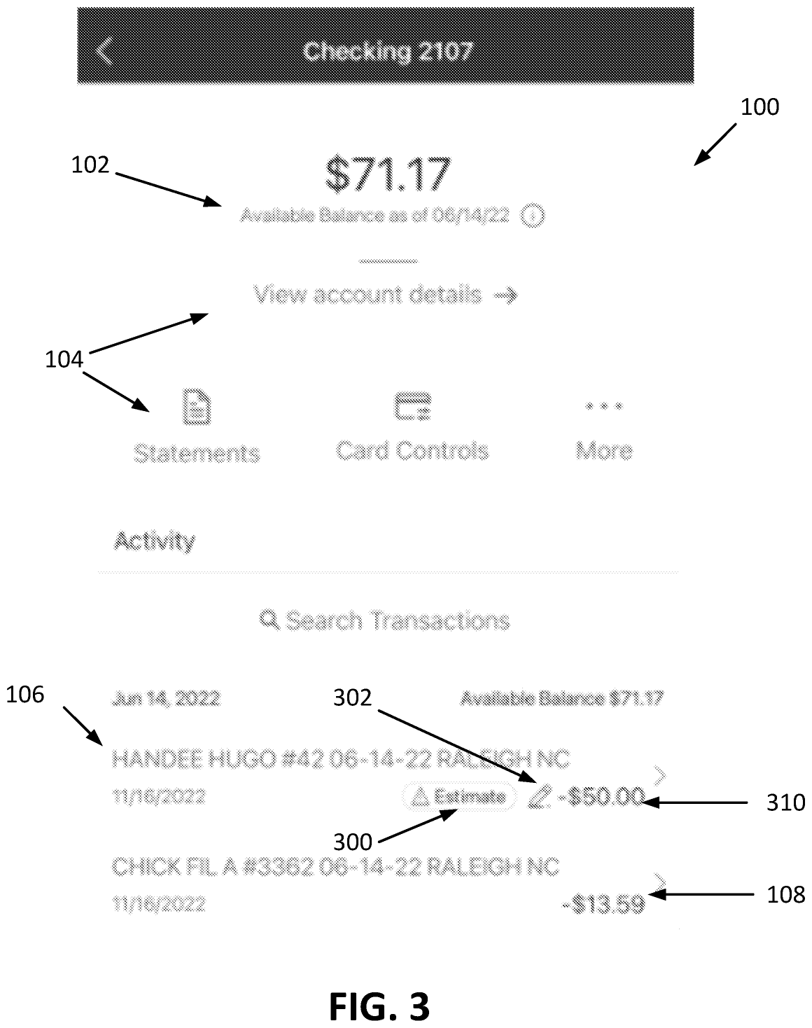

FIG. 3 is an illustration of an updated graphical user interface 100 for identifying and estimating values associated with pending events according to some examples of the present disclosure. The graphical user interface 100 can replace the preliminary value 110 shown in FIG. 1 with an estimated final value 310. The graphical user interface 100 can include an indicator 300 that indicates that the estimated final value 310 is an estimate rather than a final value associated with the pending event 107. In some examples, the user may have information related to the pending event 107 that can be used to determine a more accurate estimated final value 310. Therefore, it may be desirable to allow the user to manually input an estimated final value 310. In some examples, the graphical user interface 100 can include an interactive graphical element 302 that can enable the user to manually override the estimated final value 310. For example, the user can interact with the interactive graphical element 302 to prompt the user to enter a new estimated final value 310. In some examples where the user knows what the final value will be (e.g., the pending value plus a tip at a restaurant), the user may opt to replace the estimated final value 310 with an edited final value. The interactive graphical element 302 can be an icon or any other suitable interactive graphical element 302. The computing device can use the estimated final value 310, or the edited final value, to update the quantity 102 associated with the account. For example, the updated quantity 102 may reflect a change to the old quantity 102 (e.g., as shown in FIG. 1) based on the change between the value 110 and the updated estimated final value 310.

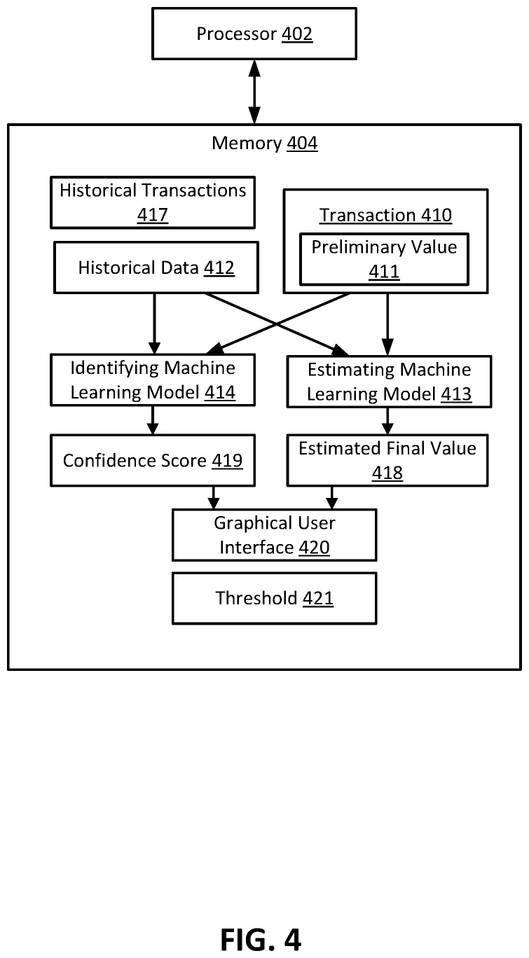

FIG. 4 is a block diagram of a system for identifying and estimating values associated with pending events according to some examples of the present disclosure. The system can include a processor 402 that is coupled to a memory 404. The memory 404 can store instructions that can be executed by a processor in the computing device 400. The processor 402 can be communicatively coupled to a memory 404. The memory 404 can include instructions that can be executable by the processor 402 for causing the processor 402 to perform operations.

The processor 402 can include one processor or multiple processors. Non-limiting examples of the processor 402 include a Field-Programmable Gate Array (FPGA), an application-specific integrated circuit (ASIC), a microprocessor, etc. The processor 402 can execute instructions stored in the memory 404 to perform one or more operations. In some examples, the instructions can include processor-specific instructions generated by a compiler or an interpreter from code written in any suitable computer-programming language, such as C, C++, C#, etc.

The memory 404 can include one memory device or multiple memory devices. The memory 404 can be volatile or non-volatile, in that the memory 404 can retain stored information when powered off. Non-limiting examples of the memory 404 include electrically erasable and programmable read-only memory (EEPROM), flash memory, or any other type of non-volatile memory. At least a portion of the memory device includes a non-transitory computer-readable medium. A computer-readable medium can include electronic, optical, magnetic, or other storage devices capable of providing the processor 402 with instructions or other program code. Non-limiting examples of a non-transitory computer-readable medium include magnetic disks, memory chips, read-only memory, random-access memory (RAM), an ASIC, a configured processor, optical storage, or any other medium from which a computer processor can read the instructions.

In some examples, the processor 402 can receive a notification associated with a pending event 410. The pending event 410 can be a transaction, or any other suitable type of pending event 410. The notification can also include details or metadata associated with the pending event 410. For example, the notification can include a preliminary value 411, as well as information corresponding to an entity, such as a company, associated with the pending event 410. The notification can further serve to indicate a pendency of the pending event 410. The pending event 410 can be awaiting resolution and may not be resolved until a sufficient amount of time has elapsed. The processor 402 can access an identifying machine-learning model 414 for identifying a pending event 410 with a preliminary value 411 that may be likely to change.

The processor 402 can access the identifying machine-learning model 414 trained on historical data 412 associated with historical pending events 417. For example, the historical data 412 can be retrieved from a database of historical pending events 417. The historical data 412 can include names of entities associated with each historical pending event 417, timestamps associated with the historical pending events 417, values associated with historical pending events 417, posted valued of the historical pending events 417, or any other suitable data associated with the historical pending events 417. The identifying machine-learning model 414 may be trained to identify pending transactions that are likely to change in value when posted. In some examples, training the identifying machine-learning model 414 can involve causing the identifying machine-learning model to identify a relationship between an input dataset of historical pending events 417 and a labeled output dataset that indicates whether the preliminary value of the pending event changed.

In some examples, the identifying machine-learning model 414 can accept metadata or other data associated with the pending event 410 as input. The processor 402 can implement the identifying machine-learning model 414 to identify a confidence score 419 associated with the likelihood that the preliminary value of the pending event 410 will change. The confidence score 419 can be a statistical parameter or any other suitable confidence score 419. In response to determining that the confidence score 419 exceeds a predetermined confidence value threshold 421, the processor 402 can output an indication to a graphical user interface 420 that the preliminary value 411 will likely change. In some examples, the processor 402 can implement the identifying machine-learning model 414 automatically for determining which of the pending events 410 have preliminary values 411 that will likely change.

The processor 402 can access an estimating machine-learning model 413 trained on the historical data 412 to identify an estimated final value 418 associated with the pending event 410. For example, the historical data 412 can be associated with historical pending events 417. The historical data 412 can include a collection of historical pending events 417 that may have been initiated by one or more users. In some examples, the historical pending events 417 can be similar to the pending event 410. Training the estimating machine-learning model 413 can involve determining a relationship between elements of an input dataset of preliminary values 411 for the historical pending events 417 and elements of an output dataset of labeled final values for the historical pending events 417. The machine-learning model 413 can use the relationship between the preliminary values 411 and the labeled final values to determine final values associated with pending events 410. The processor 402 can apply the estimating machine-learning model 413 to the preliminary value 411 to determine an estimated final value 418 for the pending event 410. In addition to the preliminary value 411, the estimating machine-learning model 413 can accept metadata or other data associated with the pending event 410 as input. For example, the estimating machine-learning model 413 can adjust the estimated final value 418 based on an entity, such as a company, associated with the pending event 410. The processor 402 can display the estimated final value 418 for the pending event to the user by outputting the estimated final value 418 to the graphical user interface 420. In some examples, the graphical user interface 420 can be displayed on a personal computer or mobile device.

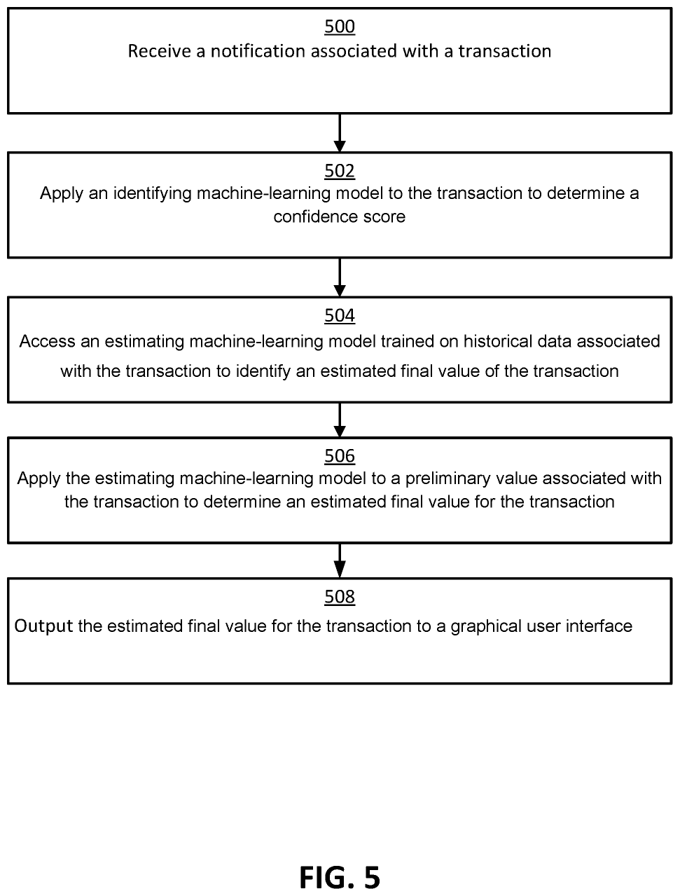

FIG. 5 is a flowchart of a process for identifying and estimating values associated with pending events according to some examples of the present disclosure. Blocks of FIG. 5 are discussed with reference to FIG. 4.

At block 500, a processor 402 receives a notification associated with a pending event. The pending event 410 can have a preliminary value 411 associated therewith. But the preliminary value 411 may be subject to change. The pending event may not be resolved until a certain amount of time has elapsed, or until a certain process has completed. In other words, the preliminary value 411 may not be indicative of a final value associated with the pending event. The notification can include metadata or other suitable forms of data associated with the pending event.

At block 502, the processor 402 applies an identifying machine-learning model to the pending event to determine a confidence score 419 associated therewith. The processor 402 can apply an identifying machine-learning model 414 to the pending event 410 and data associated with the pending event 410. The identifying machine-learning model 414 can determine whether the preliminary value 411 of the pending event 410 is likely to change. More specifically, the identifying machine-learning model 414 can determine a confidence score 419 that can indicate a probability that the pending event 410 will change. When the confidence score 419 exceeds a confidence score threshold, the preliminary value 411 of the pending event 410 may be flagged as a value that is likely to change once the pendency of the pending event 410 concludes. The identifying machine-learning model 414 can be trained on historical data 412 associated with historical pending events. In some examples, the processor 402 can apply the identifying machine-learning model 414 to pending events 410 automatically to determine which pending events 410 are likely to change.

At block 504, the processor 402 accesses an estimating machine-learning model 413 trained on historical data 412 associated with the pending event 410 to identify an estimated final value 418 of the pending event 410. The historical data 412 can include data associated with historical pending events. For example, the historical data 412 can include a collection of historical transactions made that can be associated with one or more users.

At block 506, the processor 402 applies the estimating machine-learning model 413 to a preliminary value 411 associated with the pending event 410 to determine an estimated final value 418 for the pending event 410. The estimating machine-learning model 413 can include a supervised learning model, such as a neural network. Additionally or alternatively, the estimating machine-learning model 413 can include an unsupervised learning model, such as a spatial clustering algorithm. The estimating machine-learning model 413 can accept data associated with the pending event 410 as input. For example, the estimating machine-learning model 413 can receive a name associated with the pending event 410, the preliminary value 411 associated with the pending event 410, an identifier associated with an entity that may facilitate the pending event 410, or any other suitable data associated with the pending event 410.

At block 508, the processor 402 outputs the estimated final value 418 for the pending event 410 to a graphical user interface. The processor 402 can update a quantity associated with an entity based on the estimated final value 418. For example, the graphical user interface can display a value corresponding to a quantity associated with the entity. The graphical user interface can also display a value corresponding to an updated value taking into account a change between the preliminary value 411 the estimated final value 418. Upon determining that the confidence score 419 exceeds a predetermined value, such as a confidence score threshold 421, the processor 402 can cause the graphical user interface to display the confidence score 419 and the estimated final value 418.

While the process described in FIG. 5 includes the processor 402 applying both the identifying machine-learning model 414 and the estimating machine-learning model 413, in some examples, only the estimating machine-learning model 413 may be used. For example, the processor 402 can apply the estimating machine-learning model 413 to all pending events 410 automatically. In such an example, all estimated final values generated from application of the estimating machine-learning model 413 may be output to the graphical user interface. In an additional example, only a portion of the estimated final values may be output to the graphical user interface. For example, only the estimated final values that are more than 5% different from the preliminary value of the transaction may be output to the graphical user interface. Other threshold percentage differences may also be used as a threshold for when the estimated final value is output to the graphical user interface. In such an example, the estimated final value may function as a proxy for a confidence score associated with a likelihood of a particular transaction changing in value (e.g., a proxy for using the separate identifying machine-learning model 414).

In some additional examples, the processor 402 can apply the estimating machine-learning model 413 only to pending events 410 that satisfy a certain confidence score 419 from the identifying machine-learning model 414. For example, the processor 402 may apply the estimating machine-learning model 413 to pending events 410 that have been determined to by the identifying machine-learning model 414 to have a 90% or greater probability of a final, posted value being different from the preliminary value 411. Other probability thresholds may also be used. Computing resources may be conserved by applying the estimating machine-learning model 413 to only a subset of the overall pending events 410 that meet the confidence score threshold of the identifying machine-learning model 414.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

In some examples, each process in the figures of this disclosure can be performed by one or more processing units. A processing unit may include one or more processors, including single core or multicore processors, one or more cores of processors, or combinations thereof. In some examples, a processing unit can include one or more special purpose co-processors such as graphics processors, Digital Signal Processors (DSPs), or the like. In some examples, some or most of the processing units can be implemented using customized circuits, such as Application Specific Integrated Circuits (ASICs), or Field programmable gate arrays (FPGAs).

What is claimed is:

1. A computer-implemented method comprising:
receiving, by a processor, a notification associated with a transaction;
accessing, by the processor, a machine-learning model trained on historical data associated with the transaction to identify an estimated final value of the transaction;
applying, by the processor, the machine-learning model to a preliminary value associated with the transaction to determine an estimated final value for the transaction; and
outputting, by the processor, the estimated final value for the transaction to a graphical user interface.

2. The computer-implemented method of claim 1, further comprising:
accessing, by the processor, a second machine-learning model trained on the historical data associated with the transaction to determine a likelihood that the preliminary value of the transaction will change;
applying, by the processor, the second machine-learning model to the preliminary value associated with the transaction to determine a confidence score associated with the likelihood that the preliminary value of the transaction will change; and
determining, by the processor, that the confidence score exceeds a predetermined confidence score threshold value; and
displaying, by the processor, an indication that the preliminary value is likely to change on the graphical user interface.

3. The computer-implemented method of claim 1, further comprising:
transmitting, by the processor, a notification associated with the transaction to an entity; and
in response to receiving input from the entity, displaying the graphical user interface.

4. The computer-implemented method of claim 3, further comprising:
displaying, by the processor, a value that corresponds to a quantity associated with the entity; and
updating, by the processor, the value taking into account a sum of or difference between the value and the estimated final value.

5. The computer-implemented method of claim 1, wherein the graphical user interface comprises an indicator for indicating that the estimated final value associated with the transaction is an estimate.

6. The computer-implemented method of claim 1, further comprising training the machine-learning model to determine the estimated final value for the transaction on data associated with a plurality of transactions.

7. The computer-implemented method of claim 1, further comprising:
receiving, by the processor, a selection of an interactive graphical object for altering the estimated final value; and
displaying, by the processor, an altered estimated final value.

8. A system comprising:
a processor; and
a memory comprising program code that is executable by the processor for causing the processor to:
receive a notification associated with a transaction;
access a machine-learning model trained on historical data associated with the transaction to identify an estimated final value of the transaction;
apply the machine-learning model to a preliminary value associated with the transaction to determine an estimated final value for the transaction; and
output the estimated final value for the transaction to a graphical user interface.

9. The system of claim 8, further comprising program code that is executable by the processor for causing the processor to:
access a second machine-learning model trained on the historical data associated with the transaction to determine a likelihood that the preliminary value of the transaction will change;
apply the second machine-learning model to the preliminary value associated with the transaction to determine a confidence score associated with the likelihood that the preliminary value of the transaction will change; and
determine that the confidence score exceeds a predetermined confidence score threshold value; and
display an indication that the preliminary value is likely to change on the graphical user interface.

10. The system of claim 8, further comprising program code that is executable by the processor for causing the processor to:
transmit a notification associated with the transaction to an entity; and
in response to receiving input from the entity, display the graphical user interface.

11. The system of claim 10, wherein the graphical user interface further comprises:
a value that corresponds to a quantity associated with the entity; and
an updated value taking into account a sum of or difference between the value and the estimated final value.

12. The system of claim 8, further comprising program code that is executable by the processor for causing the processor to train the machine-learning model on data associated with a plurality of transactions.

13. The system of claim 8, wherein the graphical user interface comprises an indicator for indicating that the estimated final value associated with the transaction is an estimate.

14. The system of claim 8, wherein the graphical user interface further comprises an interactive graphical object that is selectable by a user for altering the estimated final value.

15. A non-transitory computer-readable medium comprising program code that is executable by a processor for causing the processor to:
receive a notification associated with a transaction;
access a machine-learning model trained on historical data associated with the transaction to identify an estimated final value of the transaction;
apply the machine-learning model to a preliminary value associated with the transaction to determine an estimated final value for the transaction; and
output the estimated final value for the transaction to a graphical user interface.

16. The non-transitory computer-readable medium of claim 15, further comprising program code that is executable by the processor for causing the processor to:
access a second machine-learning model trained on the historical data associated with the transaction to determine a likelihood that the preliminary value of the transaction will change;
apply the second machine-learning model to the preliminary value associated with the transaction to determine a confidence score associated with the likelihood that the preliminary value of the transaction will change; and
determine that the confidence score exceeds a predetermined confidence score threshold value; and
display an indication that the preliminary value is likely to change on the graphical user interface.

17. The non-transitory computer-readable medium of claim 15, further comprising program code that is executable by the processor for causing the processor to train the machine-learning model on data associated with a plurality of transactions.

18. The non-transitory computer-readable medium of claim 15, further comprising program code that is executable by the processor for causing the processor to:
transmit a notification associated with the transaction to an entity; and
in response to receiving input from the entity, display the graphical user interface.

19. The non-transitory computer-readable medium of claim 18, wherein the graphical user interface further comprises:
a value that corresponds to a quantity associated with the entity; and
an updated value taking into account a sum of or difference between the value and the estimated final value.

20. The non-transitory computer-readable medium of claim 15, wherein the graphical user interface comprises an indicator for indicating that the estimated final value associated with the transaction is an estimate.
